(19) United States
(12) Patent Application Publication
(10) Pub. No.: US 2020/0085688 A1
(43) Pub. Date: Mar. 19, 2020

(54) PLASTIC CONTAINER PRODUCT

(71) Applicant: KOCHER-PLASTIK MASCHINENBAU GMBH, Sulzbach-Laufen (DE)

(72) Inventors: Michael SPALLEK, Ingelheim (DE); Johannes GESER, Gerlingen (DE); Alexander HAMMER, Gaildorf (DE); Alexander BEIER, Oberrot (DE); Michael SCHULTES, Fichtenau (DE)

(21) Appl. No.: 16/468,328

(22) PCT Filed: Feb. 23, 2018
(86) PCT No.: PCT/EP2018/054551

§ 371 Date: Jun. 11, 2019

(30) Foreign Application Priority Data
Mar. 7, 2017 (DE) 10 2017 002 401.4

(51) Int. Cl. A61J 1/14; B65D 47/10; B65D 51/00; B65D 1/02

(52) U.S. Cl. CPC A61J 1/1406; A61J 1/1475; B65D 1/0215; B65D 47/103; B65D 51/002; A61J 1/1412

(57) ABSTRACT

A plastic container product, in particular produced by a blow molding, filling and sealing method, comprising a container body (10) having a content of the container and an adjoining head part (12) which delimits an extraction area (14), which is closed by a head membrane (16), which has a connecting seam (38), which passes through a plane (20) spanned by the head membrane (16) and separates at least two penetrable areas (22, 24) on the free end face (26) of the head membrane (16) from each other for extracting the content of the containers, characterized in that the connecting seam (38) seen on the free end face (26) of the head membrane (16) has a course of the seam (36) at least partially deviating from a fictitious rectilinear course (32) extending within this plane (20), which is longer than the rectilinear course (32) and at least partially comprises the penetrable areas (22, 24).

The invention relates to a plastic container product, in particular produced by a blow molding, filling and sealing method, having a container body having a content of the container and an adjoining head part, which delimits an extraction area, which is closed by a head membrane, which has a connecting seam, which passes through a plane spanned by the head membrane and separates penetrable areas on the free end face of the head membrane from each other for extracting the content of the container.

Plastic containers, which are produced in a blow-molding, filling and sealing process (BFS process), as described, for example, in EP 2 269 558 A1 and also known in the professional world as the bottelpack® system, are used with great advantage for food and luxury foodstuff and in medicine for the packaging of pharmaceuticals, diagnostics, enteral nutrition and medical devices, e.g. rinsing and dialysis solutions. A significant advantage of these containers for such purposes is that the contents are solely in contact with a polymer constituting the container material, typically a plastic such as LDPE, HDPE or PP. The germ reduction/sterility of the contents can be maintained for extended periods of time using integral containers manufactured and filled using the BFS process. Containers intended for injection, infusion, transfusion or enteral nutrition have a specific shape of the head area for the formation of points of access to the contents of the container. The integral design of container and head makes for a secure sterility of the contents at a particularly efficient implementation of the manufacturing process. Caps having elastomer sealing elements (DIN ISO 15759) are applied to the container head by welding or injection molding.

In such containers—just like in other container products for medical purposes, such as injection vials, cylindrical vials or plastic containers for injections (DIN EN ISO 15747:2012-07)—polymer or elastomer particles can be punched out of the closure material, e.g. when puncturing using injection needles or piercing devices. These loose particles can remain in the cannula, the syringe, or in the container itself. This can inter alia lead to the clogging of the cannula, rendering the extraction and/or the injection procedure impossible; particles can also get into the product.

In view of this problem, EN ISO 8871-5:2014 specifies limits in the use of injection vials having an elastomeric closure, same as in the US Pharmacopoeia Chapter 381. To address this problem—also known as fragmentation—special needle geometries have been proposed by Marinacci et al. in the prior art (U.S. Pat. No. 5,868,721), which, however, necessitate costly and expensive special cannulas.

WO 81/02286 discloses a plastic container having preferred thin-walled piercing positions for a cannula arranged on a defined lateral shoulder area of the container. In this case sufficient thinning is only possible by means of a very complex tool technology, accepting retracted areas, which renders cleaning very difficult. Moreover, the container cannot be completely emptied via these thin spots because they are not at the highest or lowest point of the container.

In contrast, U.S. Pat. No. 4,574,965 (Meierhoefer) discloses a container product produced by a blow molding, filling and sealing method having a specially designed double dome geometry without thinning for the container head, in this way ensuring a secure sealing and no particle formation when it is punctured using a cannula for an extraction from the container. In this case, thin wall thicknesses in the puncturing area are not necessary. The necessary double-dome geometry permits only one puncture point and deviates very much from the proven head geometry of blow, fill and seal infusion containers designed as container products and requires special cap systems, which do not comply with the well-proven ISO standard 15759:2006-05, which in turn is costly and can impair the functional safety of the entire container system.

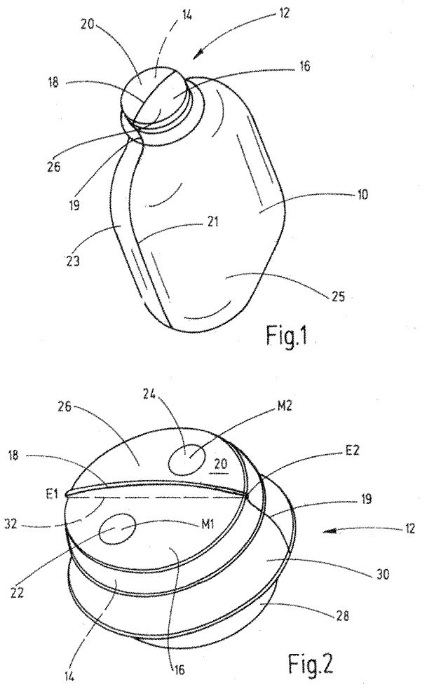

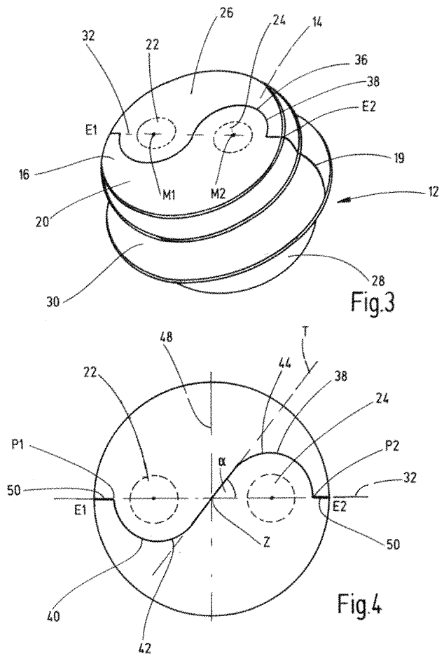

Moreover, U.S. Pat. No. 4,574,965 (FIGS. 1 and 3) shows, as does CN 85103261 A (FIGS. 1, 2 and 3), a disadvantageous course of the mold parting line in the head area (FIGS. 1 and 3: seam 18); for that reason, the puncturing point is very close to the edge of the container head and carries the real danger of unintentionally puncturing the neck area of the container with the cannula even at an only slightly divergent piercing angle. Another disadvantage is the low central rigidity of the container head, addressed in DE 10 2013 012809. In this document numerous different dome-like head shapes having multiple top surfaces are proposed for the stiffening of the head area, which also require detailed adapted cap designs and significantly reduce the puncture area compared to the top surface in accordance with DIN EN ISO 15759:2006-05. This also reduces the possible spacing between the two puncture points, which in turn can result in disadvantages in the application, for instance in the administration of infusions, if the somewhat projecting drip chamber of a pierced infusion device (EN ISO 8536-4: 2013) blocks the puncture site for the cannula, which has to be used to inject another medication during the infusion.

FIG. 4 of EP 0621027 A1 (Weiler) discloses a container having a parting line (42, “parting line”, column 8, II 26), which in an end-face view extends in a rectilinear line across the container body. Such a parting line typically results during blow molding due to the use of bi-partite molds. The parting line results from the separations of the bi-partite forming tool. The corresponding sealing or connecting seam in the head area has a minimal length and follows the course of the parting line in a rectilinear line. Just like in this example, sealed seams in general—not only in blow-molded containers—should be as short as possible to minimize the risk of weaknesses, imperfections or even leaks, which may have dire consequences for the health of the patient in the case of filled sterile containers for medical purposes.

In particular, sealing seams are sensitive and prone to occurring leaks in containers having a multilayer wall construction—for example as described in EP 1616549 B1 and DE 10347908 A1.

DE 10 2013 012 809 A1 relates to a container product, in which, instead of a uniform head membrane, which spans the end of the head part of the container body at a uniform curvature, different top surfaces are formed, which form different curvatures at the head part end, such that for the possible total extraction surface of the head membrane, an increased resistance to deflection and easier puncturing, cutting or penetration is achieved. A deflection of the head membrane during extraction and the risk of leaks are kept to a minimum and the handling is safe even when using not very sharp piercing spikes, blades or thick cannulas.

Based on this prior art, the present invention addresses the problem of providing a container product that is further improved in comparison to the known solutions, in particular regarding the handling and extraction behavior of the content of the container.

A container product having the features of claim 1 in its entirety solves this problem.

Because, according to the characterizing part of claim 1, the connecting seam seen on the free end face of the head membrane has a course of the seam at least partially deviating from a fictitious rectilinear course extending within this plane, which is longer than the rectilinear course and at least partially comprises the penetrable areas, very thin-walled, penetrable areas can be formed, which are supported by the extended connecting or sealing seam, extending in the plane of the head membrane such that there is no unintentional denting of the entire head membrane resulting in impaired extraction behavior, in particular with regard to sterility during an extraction from or addition to the contents of the containers at the respective penetrable areas. As incorrect operations are precluded in this respect, the handling of the plastic container product according to the invention as a whole is made easier for an operator and, moreover, ensures a safe addition to and/or extraction of the contents of the container in each case. The support and bracing function for the addition or extraction procedure based on the connecting seam according to the invention is also ensured by the fact that, leaving the rectilinear alignment, it at least partially encompasses the penetrable areas thus further stiffening the edges. The supporting and securing connecting seam of the head part permits the reduction of the penetrable areas on the free end face of the head membrane from the wall diameter compared to the other wall parts of the head membrane, which further facilitates the mentioned addition and/or extraction procedure.

It is surprising for a person skilled in the art that the, compared to an otherwise rectilinearly oriented course, substantially elongated connecting seam based on the known blow-molding, filling and sealing process (BFS) in a manner that is routinely safe in production, permits the manufacture of thinner areas as penetrable areas [having thicknesses] of 0.10 mm to 0.25 mm without any problems, without resulting in leaks at the connecting seam, which is also technically known as head seal seams or head welds, and without tearing occurring at the thin areas at internal pressure stresses in the temperature range above 110° C.; temperature ranges that do occur, for instance, during the sterilization of the filled container product in the context of the required autoclave process. It seems on the one hand that owing to the counter-shearing movement of the still hot polymer in the third manufacturing step of the BFS process, i.e. during the sealing of the container head part, an obviously favorable orientation of the polymer chains and/or an advantageous state of stress in the system head membrane/connecting seam/penetrable areas occurs. On the other hand, as already mentioned, the supporting effect of the connecting seam, which almost reaches the thin puncture areas, is of particular importance.

In a particularly preferred embodiment of the container product according to the invention, the course of the connecting seam is formed as a kind of sealing or welding seam, which is formed during the creation of the head part in the context of the blow molding, filling and sealing process (BFS), which seam extends on opposite sides of the head part along the latter and merges into the mold parting line that results from its production using multi-partite forming tools as part of the BFS process. In the production of the pertinent sealing seam for the head part, the penetrable areas mentioned are also formed in the head membrane in the context of the aforementioned production method, the thickness of which is reduced in comparison to the average wall thickness of the head membrane. In doing so, the sealing or welded seam fully penetrates the head membrane in a sealed manner.

It has further been found to be particularly advantageous, that the course of the seam in the head membrane merges at two opposite points into the corresponding parting lines/course of the seam in the other head part, which between them form a fictitious connecting rectilinear line, on which and/or outside of which the centers of the penetrable areas of the head membrane are located, and that in one embodiment the fictitious rectilinear line delimits at least one penetrable area in the manner of a tangent, or that this area is located at a predeterminable distance from the fictitious rectilinear line. In this way, the penetrable areas can be arranged in a supported manner on the head membrane of the container product for a variety of applications.

In this context, it has also been proven to be particularly advantageous to form the connecting seam similar to or exactly following the course of a sinusoidal wave on the head membrane, the wave trough and/or wave peak of which each receives a penetrable area of the head membrane and comprises it at least partially in a supporting manner.

In a further particularly preferred embodiment of the container product according to the invention provision is made that the head part of the container body and/or a collar between the head part and the container body is preferably firmly connected to a cap part having externally detachable or detached puncture parts, to be arranged congruently with the assignable penetrable areas of the head membrane. As the mentioned penetrable areas in the head membrane can be arranged eccentrically and the puncture parts of the cap part have to cover the penetrable areas for an extraction procedure, it is possible according to the invention and provision is made advantageously to apply the cap parts to the container rotated by a predetermined offset angle.

Further advantageous embodiments of the container product according to the invention are the subject matter of the other dependent claims.

Overall, a container product is created based on the solution according to the invention,
which can be produced safely and reproducibly by the blow-molding, filling and sealing process with a low risk of leakage,
whose container head geometry essentially corresponds to DIN ISO 15759:2006-05,
which preferably has two spatially separated, equally penetrable areas having a controlled thinner wall thickness, during the puncturing of which using a standard cannula (DIN EN ISO 7864) very few particles—if any—are punched even without a cap,
that permits low puncture forces when puncturing using a piercing device of an infusion device according to EN ISO 8536-4: 2013, and
which permits the application of cap parts having two puncture sites on the container body even in oblique positions.

Below, the solution according to the invention is explained in more detail by means of exemplary embodiments of the container product. In the schematic figures, which are not to scale

FIG. 1 shows a perspective view, reduced in size in comparison with a built embodiment, of a plastic container product in the form of an infusion container having a head part according to the prior art according to DIN ISO 15759;

FIG. 2 shows an enlarged view of the head part of the container product as shown in FIG. 1;

FIG. 3 shows a representation corresponding to FIG. 2 of an altered head part for a container product according to the invention;

FIG. 4 shows a frontal plan view of a head membrane, as used for a head part as shown in FIG. 3;

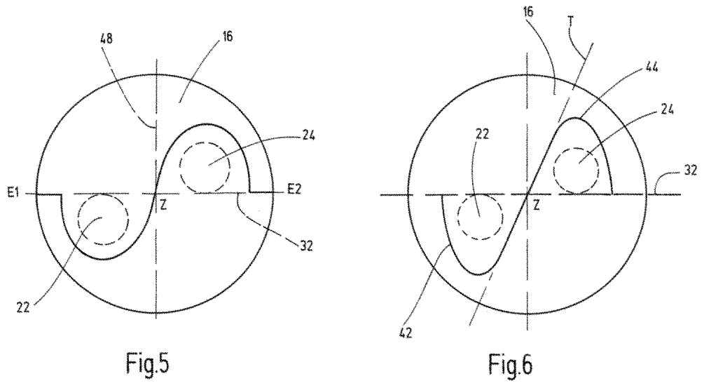

FIGS. 5 to 8 each show a representation of a head membrane corresponding to FIG. 4, but each having different courses of connecting seams and other arrangements of penetrable areas;

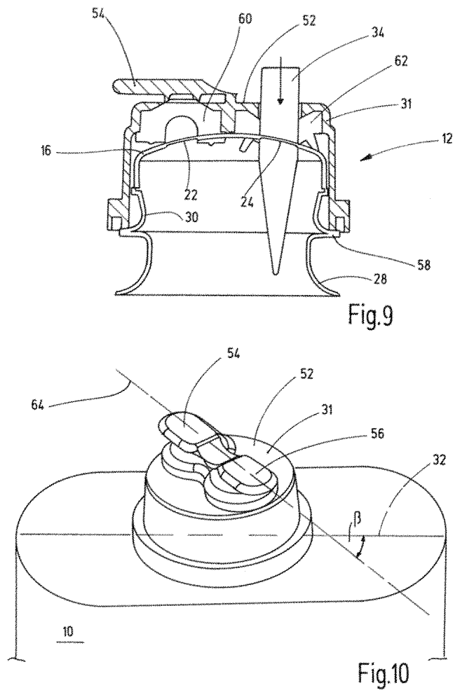

FIG. 9 shows a sectional view through a head part of a further embodiment of a container product according to the invention having a possible head membrane design according to one of FIGS. 3 to 8 having an attached cap part, wherein the state during the piercing movement using a piercing device for performing an extraction procedure of the content of the containers is shown; and

FIG. 10 shows a perspective view of the cap part of FIG. 9 having puncture parts covered by the cap, wherein the position the cap part as a whole is arranged oblique in relation to the longitudinal direction of the container product only partially shown.

FIG. 1 shows a plastic container product disclosed in the prior art (DE 10 2013 012 809 A1), which is manufactured according to the so-called blow molding, filling and sealing method (BFS), having a content of the container (not shown) of a conventional type, comprising a container body 10 and an adjoining head part 12, which delimits an extraction area 14, which is closed by a head membrane 16, which has a connecting seam 18, which extends through a plane spanned by the head membrane level 20 and which separates two penetrable areas 22, 24 on the free end face 26 of the head membrane 16 for an extraction of the content of the containers as shown in detail in FIG. 2, which areas are illustrated in idealized form as a circle having the centers M1, M2. Further components of the head part 12 are a neck part 28 and a collar part 30.

The container product shown in FIG. 1 is an infusion bottle integrally manufactured according to the BFS method, consisting of a plastic material, in particular a polyolefin material. The head part 12 formed in the example shown from the prior art in accordance with DIN ISO 15759:2006-05 can be connected to cap parts 31 in accordance with ISO 15759-BFS-A or ISO 15759-BFS-B by welding or injection molding onto the collar part 30, such as shown by way of example in FIGS. 9 and 10. The continuous and uniformly convex curved head membrane 16 is located at the free end-side end of the head part 12 for extraction and/or addition processes, which can be punctured for instance by means of a cannula (DIN EN ISO 7864) or piercing device 34 (EN ISO 8536) in the indicated arrow direction, such as in the FIG. 9 by way of example. Looked at from above in a vertical plan view of the end face 26 of the head membrane 16, the protruding curved seam 18 shown there follows a fictitious rectilinear course 32, which is shown in dashed lines in FIG. 2. This fictitious rectilinear course 32 establishes the shortest connection between two points E1 and E2, at which the known connecting seam 18 continuously merges into the adjoining shape-separating line 19 in the head part 12. The arcuate or chord-shaped connecting seam extending between the punctiform points E1 and E2 18 follows the curvature of the head membrane 16 and formed as a kind of reinforcing rib preferably protrudes by a predetermined projection beyond the free end face 26 of the head membrane 16. Furthermore, the mold parting lines 19 merge into a mold parting line 21 of the container body 10, which in the BFS process is typically formed by means of a bi-partite mold.

Viewed in the direction of FIG. 2, the two opposite penetrable areas 22, 24 are located on both sides of the curved connecting seam 18, which for the sake of a better depiction are shown as closed circles having the centers M1 and M2. However, owing to their production, the areas 22, 24 can also have other peripheral geometries, for example elliptical, crescent-shaped or the like. These penetrable or puncturable areas 22, 24 have, as is indicated in FIG. 9, reduced wall thicknesses, which are thinner than the other wall thickness of the head membrane 16. The reduced wall thicknesses of the penetrable areas 22, 24, which, as explained above, may actually have a somewhat different shape than a circular shape, result from flow processes of the material during the manufacturing process by means of the BFS process; however, they can also be intentionally obtained by appropriate shaping using suitable tools in the head membrane 16. For the sake of completeness it should be mentioned that according to ISO 15759, the diameter of the head membrane 16 can typically be 30 mm.

The connecting seam 18, which is also referred to as sealed head seam in technical terms, thus extends from the one point E1 of the head part 12 to the opposite point E2 of the same head part and, as reinforcing means in the form of a protruding rib, at least partially provides support against the unwanted indentation of the entire head membrane 16 when an extraction device, such as a cannula or a piercing device 34, is applied for a subsequent extraction or addition procedure in relation to the content of the containers. Without such a rib-like reinforcing means, puncturing the head membrane 16 would essentially not be possible when the piercing tool 34 is applied as shown in FIG. 9, but rather for a thin-walled design would be cambered inwards and prevent an effective piercing or penetration. If then, which appears to be obvious, the wall thickness of the head membrane 16 is designed having an appropriate thickness, the head membrane 16 itself forms a support even without a bead-like reinforced seam 18; then, however, an increased force is required for the piercing process by means of the piercing tool 34 and then in particular the fragmentation mentioned above occurs, where the loose plastic particles from the thickened wall areas increasingly reach the extraction channel (not shown) of the piercing tool 34, which is to be avoided in any event.

Although the rib-like reinforcing seam 18 according to the representations in the prior art according to FIGS. 1 and 2 already provides a remedy for this problem; still, it has been found in practice that this known solution for a functionally reliable and undisturbed extraction procedure for a container, in particular in the form of an infusion container, still leaves something to be desired, which can be fulfilled by the solution according to the invention as shown in FIGS. 3 et seq. For completeness sake, it should be mentioned at this point that for the extraction of the content of the container from the container by means of a piercing tool, an addition procedure of at least one medium may be provided upstream thereof, for example in the form of a drug delivery into the pre-filled container holding the container liquid, such as an infusion fluid. The piercing tool 34, which is only shown in principle in FIG. 9, can be a conventional injection needle of a syringe.

In the solution according to the invention according to FIGS. 3 and 4, the connecting seam 38 arranged on the free end face 26 of the head membrane 16, has a seam course 36 deviating from the fictitious rectilinear course 32, which extends as a surface within the plane 20 or within the bulging head membrane 16, is longer than the rectilinear course 32 and at least partially encompasses the penetrable areas 22, 24. The non-rectilinear course 36 of the connecting seam 38 according to the invention indicates the position or location of the respective penetrable areas 22, 24 at the head membrane 16 to an operator, as the connecting seam 38 comprises approximately half of the respective penetrable areas 22, 24.

As can also be seen from FIGS. 3 and 4, the connecting seam 38 extending within the plane 20 of the head membrane 16 has an alternating, preferably curved course which forms a sinusoidal wave 40, the wave trough 42 and the associated wave peak 44 of which each receive one penetrable area 22 or 24 of the head membrane 16 and thus at least partially comprises half of one. The seam course 36 in the head membrane 16 here also again merges at two opposite points E1, E2 into the other seam course in the head part 12, wherein the two opposite points E1 and E2 between them form the fictitious connecting line 32, which corresponds to the fictitious rectilinear seam 32 as shown in FIG. 2. The centers M1, M2 of the penetrable areas 22, 24 of the head membrane 16 are located on this imaginary rectilinear connecting line 32.

The head membrane 16 has a circular outer circumference and the said fictitious connecting line 32 defines a fictitious center point Z based on a further fictitious connecting line 48, which is perpendicular to the rectilinear line 32, through which the wave 40 as shown in FIG. 4 of the seam 38 according to the invention passes at the point of transition from wave valley 42 to wave peak 44.

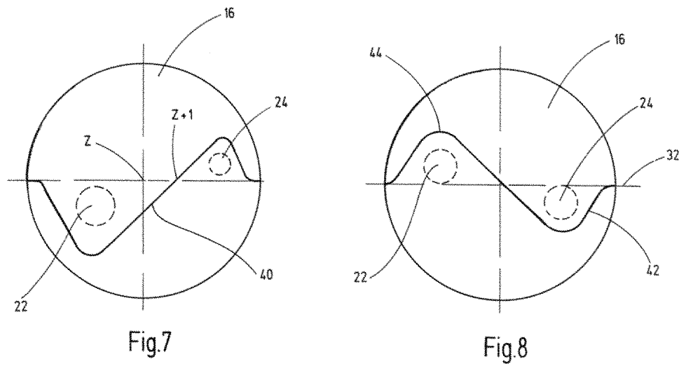

If, as shown in FIG. 4, a tangent through the center point Z is applied to the wave trough 42 and the wave peak 44, this tangent T forms an angle α of approximately 50° with the imaginary connecting rectilinear line 32. Other angular dimensions a in the range of approx. 40° (FIGS. 8) to 75° (FIG. 5) are possible depending on the embodiment of the connecting seam 38. In the embodiment shown in FIG. 7, the transition from wave trough 42 to wave peak 44 extends outside of the central fictitious center point Z through the consequently other center point Z+1, through which the tangent would then have to be centered, as shown in FIG. 4. The angle α, however, remains unchanged.

As is further apparent from FIGS. 3 and 4, the start P1 of the wave trough 42 and the start or end P2 of the wave peak 44 of a wave 40 of the connecting seam 38 in each case transition into a section 50, which in turn viewed in plan view, towards the end face 26 of the head membrane 16, extends along the fictitious connection line 32, wherein the respective sections 50 at the edge open into the opposite positions E1, E2 on the head part 12. Instead of rectilinearly selected sections 50, these can also have an arcuate course in continuation of the sine wave 40 or in the opposite direction to this wave path. The length of the wave-shaped connecting seam 38 is preferably selected to be longer than the diameter of the circularly shaped head membrane 16 by at least 30%.

The penetrable or puncturable areas 22, 24 on the head membrane 16 are selected to be largely equal in size in the exemplary embodiment shown in FIGS. 3 and 4. As is further shown in FIG. 9, the two penetrable areas 22, 24 on the head membrane 16 have wall thicknesses, which are thinner than the other average wall thickness of the remaining head membrane 16, and the average wall thickness of a penetrable area 22, 24 is preferably between 0.15 mm and 0.35 mm. The wall thicknesses for each penetrable area 22, 24 can also be chosen differently, such that, for example, a penetrable area is particularly suitable for introducing a piercing cannula and another penetrable area permits good accessibility for the introduction of a syringe needle. Furthermore, the two surfaces of the penetrable areas 22, 24 can be selected to be of different sizes, as shown by way of example in FIG. 7 for a head membrane 16 changed in that respect, wherein in one embodiment of a head membrane 16 as shown in FIG. 8 the sequence from wave trough 42 to wave peak 44 is altered such that viewed in the direction of FIG. 8, on the left side the wave peak 44 occurs before the wave trough 42.

The connecting seam 38 on the individual head membrane 16 may protrude in the manner of a reinforcing rib at least partially outwardly towards the environment and/or in the direction of the interior of the container body 10, wherein an outward protrusion for the known solution according to the FIG. 2 is shown there. For the sake of simplicity, the rib design was omitted in the illustration in FIGS. 3 et seq. The head membrane 16 shown in the figures is shown in each case as a curved surface in the form of the plane 20, which projects convexly outwards towards the environment. However, it is quite possible to form the head membrane 16 as a plane, i.e. an uncurved, planar plane (not shown). A polyethylene, a cyclic olefin polymer, a polypropylene but also a cyclic olefin copolymer, a polypropylene copolymer or a polypropylene blend can be used routinely as a plastic material for the container body 10. Furthermore, the container wall of the container according to the invention may have a multilayer structure (not shown) of at least two materials.

In order to obtain the wave-shaped connecting seam 38, the molding tools in the case of a corresponding molding device have to be designed such that they have the required mold recesses and protrusions on their opposite end faces in order to obtain the wave form for the head part 12. Such a molding device for moving molding tools for generating pertinent head geometries in plastic containers having slide control is shown in DE 103 17 712 A1 by way of example. The waveform shown in the figures for the connecting seam 38 has proven to be particularly advantageous in terms of manufacturing. However, other waveforms can be selected, for example, in the manner of an S-shaped arc having different courses of the curve. Furthermore, meandering seam courses or zigzag seam courses can be implemented, if required. It is important to select the course of the seam of the connecting seam 38 such that the respective penetrable areas 22, 24 are at least partially enclosed in order to sufficiently stabilize them during piercing. Furthermore, the elongated course of the seam 36 results in an improved reinforcement of the otherwise soft plastic head membrane 16. Furthermore, more than two penetrable areas can be mounted on the head membrane 16 (not shown).

The further embodiments of the head membrane 16 for a container product according to the invention as shown in the images in FIGS. 5 to 8 are explained only insofar as they differ substantially from the preceding embodiments and if they have not been sufficiently explained above.

In the embodiment of a head membrane 16 shown in FIG. 5, the imaginary connecting rectilinear line 32 is tangent to the upper side of the penetrable area 22, and the further penetrable area 24 has a predeterminable axial distance to this connecting rectilinear line 32. In the embodiment shown in FIG. 6, the tangent T applied to wave trough 42 and wave peak 44, which passes through the center point Z, is steeper than that in the embodiment shown in FIG. 4. Furthermore, as a further tangent, viewed in the direction of FIG. 6, the connecting line 32 touches the top of the penetrable area 22 and the bottom of the further penetrable area 24, both of which are approximately the same size in terms of area.

In the embodiment shown in FIG. 7, the penetrable area 24 is selected to be smaller in diameter than the penetrable area 22. Furthermore, as explained above, the course of the wave 40 through the further center point Z+1 is offset off center from the center point Z. In the embodiments shown in FIG. 8, the two penetrable areas 22, 24, which are approximately equal in size, are tangent to the connecting rectilinear line 32 and, as explained above, the course from wave trough 42 to wave peak 44 is reversed according to the exemplary embodiments shown in FIGS. 3 to 7.

In the exemplary embodiment according to FIGS. 9 and 10, the cap part 31 is placed on the head part 12 in a manner known per se. The cap part 31 is preferably made of a rigid plastic material, which generally has the shape of a circular cup 52 having a bottom and detachable tabs 54, 56, of which, as shown in FIG. 9, the right tab 56 is removed for an extraction procedure by means of the piercing tool 34. The lower edge of the cap part 31 is integrally attached to a flange part 58, which extends at the head part 12 between the collar part 30 and the neck part 28. For the sake of simplicity, FIG. 9 does not show the container body 10, which may also have a different shape than the container body 10 shown in FIG. 1 as shown in FIG. 10. The cap part 31 has two puncture parts 60, 62, which cover the respective penetrable areas 22, 24 in an assigned manner (see FIG. 9). The puncture parts 60, 62 each form a type of sealing part and are preferably formed of an elastomeric material having a low rigidity and low hardness. Preferably, thermoplastic elastomers are used for the puncture parts 60, 62, which can be joined to the cap part 31 in a simple manner by a substance-to-substance bond, for instance by welding.

As is apparent from the illustration of FIG. 10, the transition in the form of the neck part 28 between the other head part 12 and the top of the container of the container body 10 has been omitted for the sake of simplicity. Furthermore, the solution having a cap part 31 according to FIGS. 9 and 10 provides a particularly safe solution, as the penetrable areas 22 and 24 are only detached for an extraction or addition procedure after the removal of the respective tabs 54 and/or 56, in which case the piercing tool 34 has yet to penetrate the respective elastomeric puncture parts 60, 62.

Furthermore, the solution according to the invention, as shown in particular in FIG. 10, can be used to set the cap part 31 on the head part 12 assigned to the penetrable areas 22, 24 in an offset. In this way, the two penetrable areas 22 and 24 can be on (FIG. 4) or outside (FIGS. 5-8) of the fictitious connecting rectilinear connecting line 32, such that in this respect the longitudinal axis 64 drawn through the two tabs 54, 56 forms an offset angle β with the fictitious rectilinear line 32, which can in the exemplary embodiment of FIG. 10 form an angle of approximately 45°; but may also readily have values between 0° (FIG. 4) and approx. 30° (FIG. 5) and more. Thus, it is possible depending on the purpose, to orient the cap orientation of the cap part 31 for a BFS bottle and its two openings 60, 62 in parallel to the axis 32 of the container 10; but also to design it having other cap orientations, preferably between 0° to 50°, to the longer transverse axis or connecting line 32 of the container bottle 10 as shown in the image of FIG. 10.

1. A plastic container product, in particular produced by a blow molding, filling and sealing method, comprising a container body (10) having a content of the container and an adjoining head part (12) which delimits an extraction area (14), which is closed by a head membrane (16), which has a connecting seam (38), which passes through a plane (20) spanned by the head membrane (16) and separates at least two penetrable areas (22, 24) on the free end face (26) of the head membrane (16) from each other for extracting the content of the containers, characterized in that the connecting seam (38) seen on the free end face (26) of the head membrane (16) has a course of the seam (36) at least partially deviating from a fictitious rectilinear course (32) extending within this plane (20), which is longer than the rectilinear course (32) and at least partially comprises the penetrable areas (22, 24).

2. The container product according to claim 1, characterized in that the connecting seam (38) extends from one point (E1) of the head part (12) to an opposite point (E2) thereof and as reinforcing means at least partially provides support against the unwanted indentation of the head membrane (16).

3. The container product according to claim 1, characterized in that the course of the connecting seam (38) and the reinforcing means provide a user with an indication of the position of the respective penetrable area (22, 24) on the head membrane (16).

4. The container product according to claim 1, characterized in that the connecting seam (38) extending within the plane (20) of the head membrane (16) has an alternating, preferably curved course.

5. The container product according to claim 1, characterized in that the curved course is largely similar to a single, preferably sinusoidal wave (40), the wave trough (42) and/or wave peak (44) of which each receive a penetrable area (22, 24) of the head membrane (16) and thus at least partially comprises the latter.

6. The container product according to claim 1, characterized in that the course of the seam (36) of the connecting seam (38) is formed as a kind of parting line, which is formed during the creation of the head part in the course of the blow molding, filling and sealing process, which seam further extends (19) along opposite sides of the head part (12) and merges into a mold parting line (21) of the container body (10) which line results from its production using multi-partite forming tools as part of that process.

7. The container product according to claim 1, characterized in that the course of the seam (36) in the head membrane (16) merges into the course of the seam (19) in the head part (12) at two opposite points (E1, E2), which between them form a fictitious connecting line (32), on which and/or outside of which the centers (M1, M2) of the penetrable areas (22, 24) of the head membrane (16) are located, and that in one embodiment the fictitious rectilinear line (32) delimits at least one penetrable area (22, 24) in the manner of a tangent, or that this area is located at a predeterminable distance from the fictitious straight line (32).

8. The container product according to claim 1, characterized in that the head membrane (16) has a circular outer circumference and the fictitious connecting line (32) with another fictitious connecting line (48), which is perpendicular to the former, define a fictitious center point (Z) at the point of their intersection through which the wave (40) of the seam (38) passes at the point of transition from the wave trough (42) to the wave peak (44).

9. The container product according to claim 1, characterized in that a tangent (T) is applied to the trough (42) and/or the crest (44) passes through the fictitious center point (Z) or another center point (Z+1), forms an angle α with the fictitious connecting line (32) from 10 to 90 degrees, preferably from 30 to 70 degrees, even more preferably from 40 to 60 degrees.

10. The container product according to claim 1, characterized in that the sequence of wave trough (42) to wave peak (44) is reversed.

11. The container product according to claim 1, characterized in that the starts (P1, P2) of wave trough (42) and/or wave crest (44) of a wave (40) of the connecting seam (38) merges into a section (50), which in plan view, viewed on the front side (26) of the head membrane (16), extends along the fictitious connection line (32) and open into the respective opposite points (El, E2) on the head part (12).

12. The container product according to claim 1, characterized in that the length of the connecting seam (38) is at least 20%, preferably at least 30% longer than the diameter of the preferably circular designed head membrane (16), viewed in its end view.

13. The container product according to claim 1, characterized in that the penetrable areas (22, 24) on the top membrane (16) have wall thicknesses which are thinner than the other average wall thickness of the head membrane (16), in particular in the area of the connecting seam (38), and the average wall thickness of a penetrable area (22, 24) is between 0.10 mm to 0.40 mm, preferably between 0.15 mm and 0.35 mm.

14. The container product according to claim 1, characterized in that the wall thicknesses and/or the surfaces of the two penetrable areas (22, 24) on the head membrane (16) are of different sizes.

15. The container product according to claim 1, characterized in that the connecting seam (38) on the top membrane (16) protrudes in the manner of a reinforcing rib at least partially outwards towards the environment and/or in the direction of the interior of the container body (10).

16. The container product according to claim 1, characterized in that the head part (12) of the container body (10) and/or a collar (30) between the head part (12) and the container body (10) is preferably firmly connected to a cap part (31), having externally detachable or detached puncture parts (60, 62), which are arranged overlapping with the assignable, penetrable areas (22, 24) of the head membrane (16).

17. The container product according to claim 1, characterized in that, depending on the position of the penetrable areas (22, 24) in the head membrane (16), the positioning device of the respective piercing parts (60, 62) of the cap part (31) is attached to the head part (12) at an offset angle β of less than 70°, preferably less than 50°, more preferably less than 30° relative to the fictitious rectilinear connecting line (32).

18. The container product according to claim 1, characterized in that the cap part (31) is attached to a reinforcing rib on the free end face (26) of the head membrane (16), which is preferably formed from the connecting seam (38).

19. The container product according to claim 1, characterized in that the head membrane (16) has an unbent, planar or a curved plane (20), which projects convexly outwards to the environment.

20. The container product according to claim 1, characterized in that the plastic material used is a polyethylene, a polypropylene, a polypropylene copolymer or a polypropylene blend as a container material and/or that the container wall of the container body (10) has a multilayer structure of at least two materials.
